(19) United States
(12) Patent Application Publication
(10) Pub. No.: US 2006/0235887 A1
(43) Pub. Date: Oct. 19, 2006

(54) Terminal device, content deletion and transfer control system, and method for controlling content deletion

(76) Inventors: Koichi Abe, Iwaki-city (JP); Hisayuki Watanabe, Iwaki-city (JP)

Correspondence Address: BRINKS HOFER GILSON & LIONE, P.O. BOX 10395, CHICAGO, IL, 60610, US

(21) Appl. No.: 11/402,304

(22) Filed: Apr. 11, 2006

(30) Foreign Application Priority Data
Apr. 13, 2005 (JP) 2005-116165

(51) Int. Cl. G06F 17/00

(52) U.S. Cl. 707/104.1

(57) ABSTRACT

A terminal device that is virtually connected to an external information processing device that includes a recording medium that stores content so that the terminal device can communicate with the information processing device includes an input unit for receiving a user's instruction, a display unit that presents information on a screen, an information storage unit that stores content, and a control unit that is connected to the input unit, the display unit, and the information storage unit. The control unit creates a deletion history when a piece of content stored in the information storage unit is deleted, and displays the deletion history on the screen of the display unit and requests the information processing device to transfer a deleted piece of content that has been selected from the deletion history when a user's instruction has been received via the input unit.

### BACKGROUND OF THE INVENTION

1. Field of the Invention

The present invention relates to methods for controlling deletion of content stored in terminal devices, and in particular, relates to a terminal device that can connect to and communicate with an information processing device that includes a relatively large capacity recording medium and a limited-capacity recording medium that stores data (content), for example, a music file, obtained from the information processing device, a system that performs control operations related to deletion and transfer of content between the terminal device and the information processing device, and a method for controlling content deletion.

2. Description of the Related Art

Recently, broadcast services have been digitized, and new types of service, for example, interactive services and storage-type services, have been started. Moreover, audio-visual (AV) devices, for example, compact disk (CD) players and digital versatile disk (DVD) players, have been connected to networks in, for example, a situation in which broadband networks are available, and home personal computers (PCs) have had AV functions. In such situations, the next-generation data platform needs to, for example, enable high-speed access, handle various types of data, and be capable of being shared by AV devices and PCs. Hard disk drives (HDDs) are typical information recording media that satisfy these requirements. Recently, HDDs (removable HDDs) that can be removed and are portable have been proposed.

HDDs are also used as in-vehicle recording media. For example, music files in, for example, the MPEG-1 Audio Layer-3 (MP3) format can be copied from an in-vehicle CD player to a typical in-vehicle HDD. A typical removable HDD that stores music files can be removed from a vehicle and connected to a home PC with a cable such as a universal serial bus (USB) cable to transfer music files. Moreover, recently, a system that uses a wireless local area network (LAN) to copy music files stored in a home PC to an in-vehicle HDD has been studied.

In the conventional art, when content such as music files is transferred from a PC to an in-vehicle terminal device, the PC checks the contents in the PC and the in-vehicle terminal device, and only the difference between the contents is transferred. This facilitates lowering the communication costs in a case where these devices are connected to each other through wireless communication and the time required for transferring data needs to be reduced. In this case, the difference between the contents corresponds to additional content, i.e., new content that has been added in the PC in a situation in which the content, for example, music files, stored in the PC is the same as that stored in the in-vehicle terminal device, and a part of the content in the in-vehicle terminal device that has been deleted is not treated as the difference to be transferred.

An in-vehicle HDD is also used as a medium for storing data such as map data for navigation other than data such as music files. In this situation, the capacity of an in-vehicle HDD is limited compared with that of an HDD of a home PC. Thus, in view of an efficient operation, it is preferable that the volume of data that is constantly stored in an in-vehicle HDD be minimized. That is to say, since vehicles constantly need data for navigation, it is preferable that the volume of data such as music files that is temporarily required for entertainment be minimized. Thus, an in-vehicle terminal device provided with a known HDD has a function related to deleting data such as music files that is externally obtained from, for example, a home PC.

A typical method for deleting data in this manner is disclosed in Japanese Unexamined Patent Application Publication No. 10-178611, which, in an electronic camera, distinguishes first image files stored in a first storage area from second image files stored in the first storage area that can be deleted because the second image files have been transferred to a second storage area so that the first and second image files can be deleted through different displays and by different operations. Moreover, another method is disclosed in Japanese Unexamined Patent Application Publication No. 2004-062957, which, in a recording and reproducing apparatus that uses recording media, determines whether the backup data of data recorded in one recording medium exists in another recording medium so that data that has not been backed up is prevented from being erroneously deleted by sending a warning to a user when the user tries to delete such data.

In an in-vehicle terminal device provided with a known HDD, the capacity of the HDD is limited as described above. Thus, in view of an efficient operation, data (content) such as music files that is copied from an external information processing device such as a home PC is deleted as necessary.

Accordingly, a problem exists, such that a user cannot play back with an in-vehicle terminal device music recorded in a music file that has been deleted from the in-vehicle terminal device because the data of the music file has been deleted from the HDD. In this case, the problem does not occur when the same content as the music file can be externally obtained in any way in a case where the music file has been deleted from the in-vehicle terminal device. However, in the conventional art, only additional content in a PC (the difference between the contents in the PC and an in-vehicle terminal device) is transferred from the PC to the in-vehicle terminal device, and a part of the content in the in-vehicle terminal device that has been deleted is not to be transferred, as described above.

Moreover, no problem occurs when a user correctly specifies content to be deleted and deletes the specified content. However, a user may still erroneously delete content that the user needs to keep. An in-vehicle terminal device provided with a known HDD does not sufficiently protect against such misoperation by a user. The above-described problems may also occur in a case where the content to be transferred is video data other than audio data, such as music files.

### SUMMARY OF THE INVENTION

In view of the problems in the conventional art, it is an object of the present invention to provide a terminal device, a content deletion and transfer control system, and a method for controlling content deletion, in which deleted content can be externally obtained as necessary and an efficient operation of a limited-capacity recording medium can be achieved.

In view of the aforementioned problems in the conventional art, according to a first aspect of the present invention, a terminal device that is virtually connected to an external information processing device that includes a recording medium that stores content so that the terminal device can communicate with the external processing device includes an input unit operable to receive a user's instruction, a display unit operable to present information, a storage unit operable to store content, and a control unit connected to the input unit, the display, and the storage unit. The control unit creates a deletion history when a piece of content stored in the storage unit is deleted, and displays the deletion history on the display and requests the external processing device to transfer a deleted piece of content that has been selected from the deletion history via the user's instruction.

Thus, a piece of content that was deleted from the terminal device can be obtained from the outside of the terminal device as necessary. Moreover, even when the capacity of the information storage unit, for example, an in-vehicle HDD, that stores content is limited, the stored content can be deleted as necessary. Thus, an efficient operation of the recording medium (information storage unit) can be achieved.

According to a second aspect of the present invention, a terminal device that is connected to an external information processing device that includes a recording medium that stores content so that the terminal device can communicate with the information processing device includes an input unit operable to receive a user's instruction, a storage unit operable to store content, and a control unit that is connected to the input unit and the storage unit. The control unit does not immediately delete a piece of content stored in the storage unit when deletion of the piece of content is requested but rather places the piece of content into a deletion-pending queue and only actually deletes the piece of content after the control unit has determined that the piece of content exists in the recording medium of the external processing device.

Thus, a piece of content that was deleted from the terminal device can be obtained from the external information processing device as necessary like the terminal device according to the first aspect of the present invention. Accordingly, an efficient operation of the recording medium (information storage unit) can be achieved.

Moreover, according to a third aspect of the present invention, a content deletion and transfer system is provided for each of the terminal devices according to the foregoing aspects of the present invention. Moreover, according to a fourth aspect of the present invention, a method for controlling content deletion is provided for each of the terminal devices according to the foregoing aspects of the present invention. The details of the content deletion and transfer system and the method for controlling content deletion will be described below in embodiments of the present invention.

### BRIEF DESCRIPTION OF THE DRAWINGS

FIG. 1 is a schematic block diagram showing the structure of a content deletion and transfer control system according to embodiments of the present invention;

FIG. 2 is a flowchart showing the process of deletion and transfer of content according to a first embodiment that is performed by an in-vehicle terminal in the system shown in FIG. 1;

FIG. 3 is flowchart showing the process of deletion and transfer of content according to a second embodiment that is performed by the in-vehicle terminal in the system shown in FIG. 1;

FIGS. 4A and 4B are schematic views each showing the states of files (content) stored in individual HDDs of a PC and the in-vehicle terminal;

FIGS. 5A, 5B, and 5C are views each showing a typical screen display of deletion history; and

FIGS. 6A and 6B are schematic views each showing a process of transferring a file from the PC to the in-vehicle terminal.

### DESCRIPTION OF THE PREFERRED EMBODIMENTS

Embodiments according to the present invention will now be described with reference to the attached drawings.

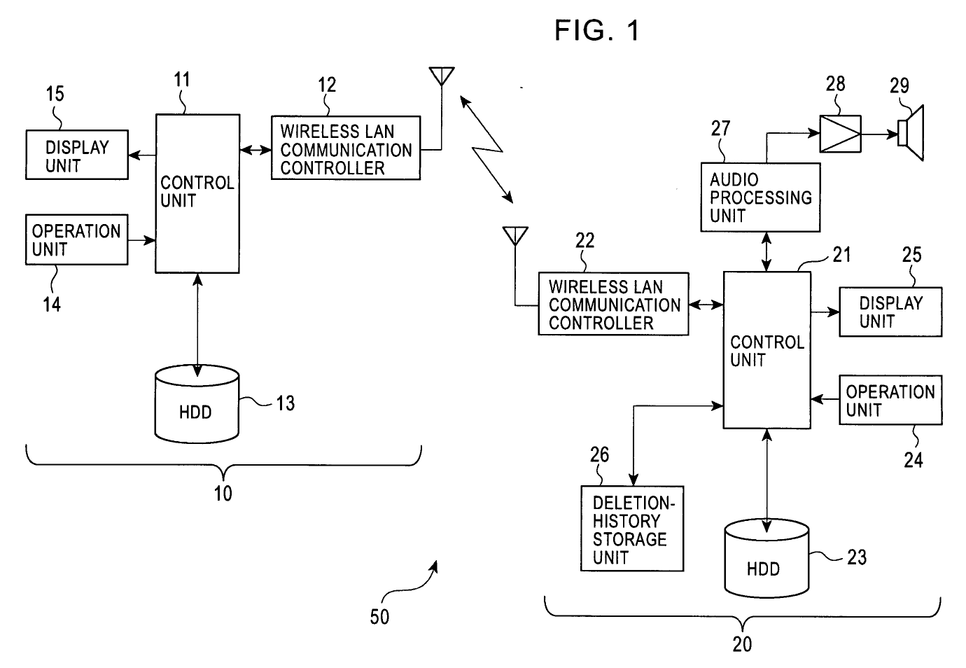

FIG. 1 is a schematic view showing the structure of a content deletion and transfer control system according to the embodiments of the present invention.

The content deletion and transfer control system 50 according to the embodiments includes an in-vehicle terminal device (in-vehicle audio device) 20 and a home PC 10 serving as an information processing device that includes a recording medium. The PC 10 is connected to the in-vehicle terminal device 20 via a wireless LAN. In the embodiments, the ad hoc mode is adopted as the communication mode, in which the PC 10 and the in-vehicle terminal device 20 directly communicate with each other, as shown in FIG. 1. Alternatively, the infrastructure mode may be adopted as the communication mode, in which the PC 10 and the in-vehicle terminal device 20 communicate with each other via an access point of a wireless LAN. When the infrastructure mode is adopted, the in-vehicle terminal device 20 can be connected via an access point to the PC 10 through the air and to, for example, a wired LAN and the Internet with cables.

The PC 10 includes a control unit 11, a wireless LAN communication controller 12, an HDD 13, an operation unit 14, and a display unit 15. The components of the PC 10 are connected to the control unit 11.

The control unit 11 includes a central processing unit (CPU), a random access memory (RAM), and a read only memory (ROM) that are not shown. In the present invention, the control unit 11 controls deletion and acquisition (transfer) of content and deletion control that are performed by the in-vehicle terminal device 20 cooperating with the PC 10, as described below. The wireless LAN communication controller 12 includes, for example, an expansion card (what is called a wireless LAN card) that has a function of connecting to a wireless LAN. The wireless LAN communication controller 12 functions as an interface that controls transfer of data (in this case, content of music files) between the PC 10 and the in-vehicle terminal device 20 through the air. That is to say, the data of music files that is transferred from the in-vehicle terminal device 20 is sent to the PC 10 via the wireless LAN communication controller 12 and stored in the HDD 13 under the control of the control unit 11, and the data of music files that is stored in the HDD 13 is read by the control unit 11 as necessary and transmitted to the outside (in this case, to the in-vehicle terminal device 20) via the wireless LAN communication controller 12.

The HDD 13 stores the data of music files that is compressed (encoded) by an audio signal compression method such as MP3 in the embodiments. Music files include the information (for example, the names of tunes, the names of artists, and the names of albums) on the content of the music files in addition to music data (data body). The operation unit 14 is a keyboard that includes various types of operation key for receiving the user's operation instructions. In the embodiments, at least, the operation unit 14 includes operation keys for playing back music files stored in the HDD 13, transferring music files to the in-vehicle terminal device 20, and checking the existence of music files stored in the HDD 13. The display unit 15 includes, for example, a liquid crystal display (LCD) panel or a cathode ray tube (CRT). The screen of the display unit 15 displays under the control of the control unit 11 the information related to various types of operation instruction that are received via the operation unit 14. In the embodiments, the screen displays the result of checking the existence of music files stored in the HDD 13 and the information (for example, the names of tunes, the names of artists, and the names of albums) on the content of music files if any exists.

The in-vehicle terminal device 20 includes a control unit 21, a wireless LAN communication controller 22, an HDD 23, an operation unit 24, a display unit 25, a deletion-history storage unit 26, an audio processing unit 27, a power amplifier 28, and a speaker 29. The components of the in-vehicle terminal device 20 are connected to the control unit 21.

The control unit 21 includes a CPU, a RAM, and a ROM that are not shown, like the control unit 11 of the PC 10. In the present invention, the control unit 21 controls storage and deletion of music files (content) stored in the HDD 23, as described below. The following cases are subjected to deletion control: a case where the stored content is deleted in response to a user's instruction from the operation unit 24 and a case where the stored content is not deleted immediately but is put into a deletion-pending state when a user has submitted an instruction to delete the content. Thus, in the latter case, the content to be deleted remains in a storage area of the HDD 23 and is deleted from the storage area subsequently when deletion of the content is actually performed. The wireless LAN communication controller 22 includes a wireless LAN card, like the wireless LAN communication controller 12 of the PC 10. The wireless LAN communication controller 22 functions as an interface that controls transfer of data (in this case, content of music files) between the PC 10 and the in-vehicle terminal device 20 through the air. That is to say, the data of music files that is transferred from the PC 10 is sent to the in-vehicle terminal device 20 via the wireless LAN communication controller 22 and stored in the HDD 23 under the control of the control unit 21, and the data of music files that is stored in the HDD 23 is read by the control unit 21 as necessary and transmitted to the audio processing unit 27 or the outside (in this case, to the PC 10) via the wireless LAN communication controller 22.

The HDD 23 stores the data of music files, like the HDD 13 of the PC 10. The operation unit 24 is, for example, provided together with the display unit 25 in a console panel (operation panel) that is located in front of a front seat in a vehicle cabin. The operation unit 24 includes various types of operation keys for receiving a user's operation instructions. In the embodiments, at least, the operation unit 24 includes operation keys for instructing playing back of music files stored in the HDD 23, transferring music files to the PC 10, and performing deletion and acquisition of content and deletion control in the in-vehicle terminal device 20 as described below. Other than the above-described case where the operation unit 24 is provided in the operation panel, the operation unit 24 may include a remote control receiver and a remote control transmitter that supplies operation instruction signals in the form of, for example, infrared signals to the remote control receiver.

The display unit 25 includes, for example, an LCD panel or an organic electroluminescence (EL) panel. The screen of the display unit 25 displays under the control of the control unit 21 the information related to various types of operation instruction that are entered via the operation unit 24. In the embodiments, the screen displays the information (for example, the names of tunes, the names of artists, and the names of albums) on the content of music files stored in the HDD 23, the deletion history of file deletion or issue of instructions for deleting files, and a warning message stating the status upon attempted deletion of a file subjected to deletion from the storage area of the HDD 23 when the corresponding file does not exist in the HDD 13 of the PC 10.

The deletion-history storage unit 26 includes a memory, such as a RAM, and stores information related to the deletion history of deleted files (content). The deletion history includes the information (the information stating that the relevant files have not been deleted) on files that were not deleted immediately but were put into a deletion-pending state when a user submitted an instruction to delete the files in addition to the information (the information for identifying files, for example, the names of albums and the names of tunes) on files that have been actually deleted among files stored in the HDD 23. In the embodiments, the deletion-history storage unit 26 is provided separate from the HDD 23. When the HDD 23 has sufficient capacity, the information related to the deletion history may be stored in a part of the storage area of the HDD 23.

The audio processing unit 27, under the control of the control unit 21, decompresses (decodes) the digital data of music files that is read from the HDD 23, performs digital-to-analog conversion on the decompressed data, and generates analog audio signals. The audio signals produced from the audio processing unit 27 are amplified through the power amplifier 28 and sent to the speaker 29.

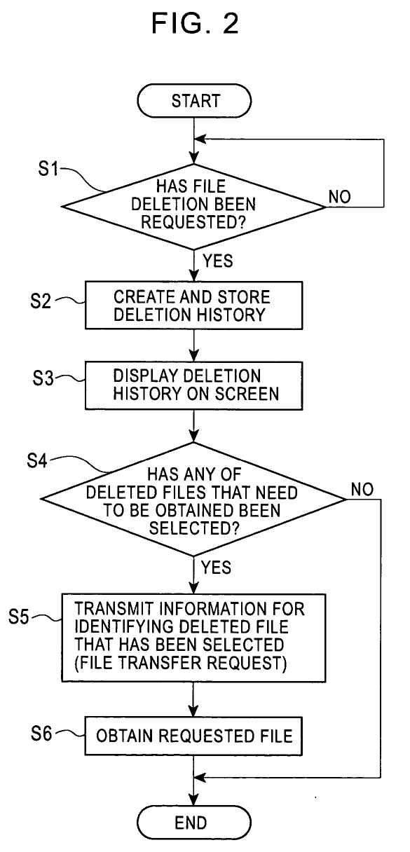

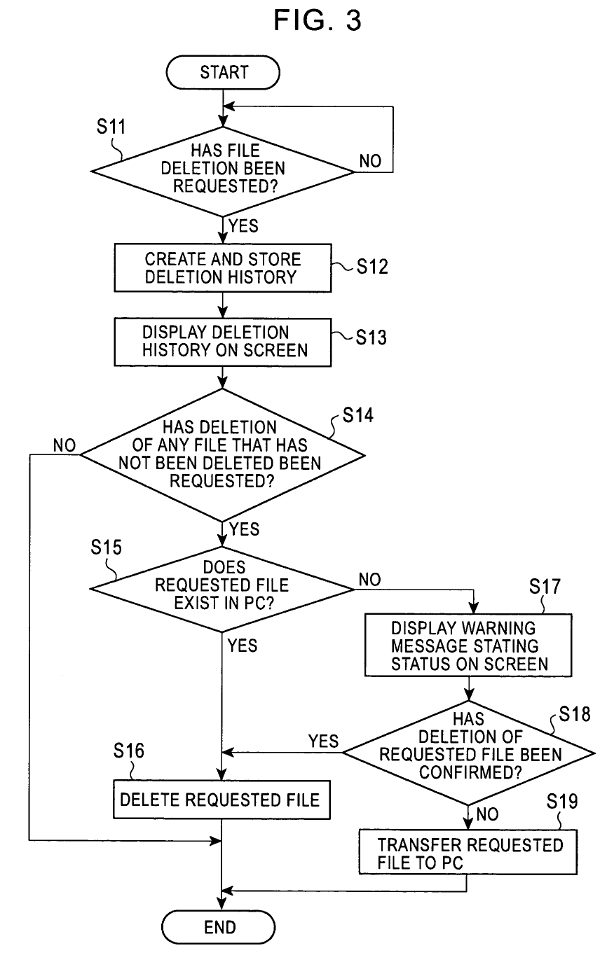

The process of deletion and transfer of content that is performed by the in-vehicle terminal device 20 in the content deletion and transfer control system 50 shown in FIG. 1 will now be described with reference to FIGS. 2 to 6. FIG. 2 shows the process of deletion and transfer of content according to a first embodiment. FIG. 3 shows the process of deletion and transfer of content according to a second embodiment.

First Embodiment

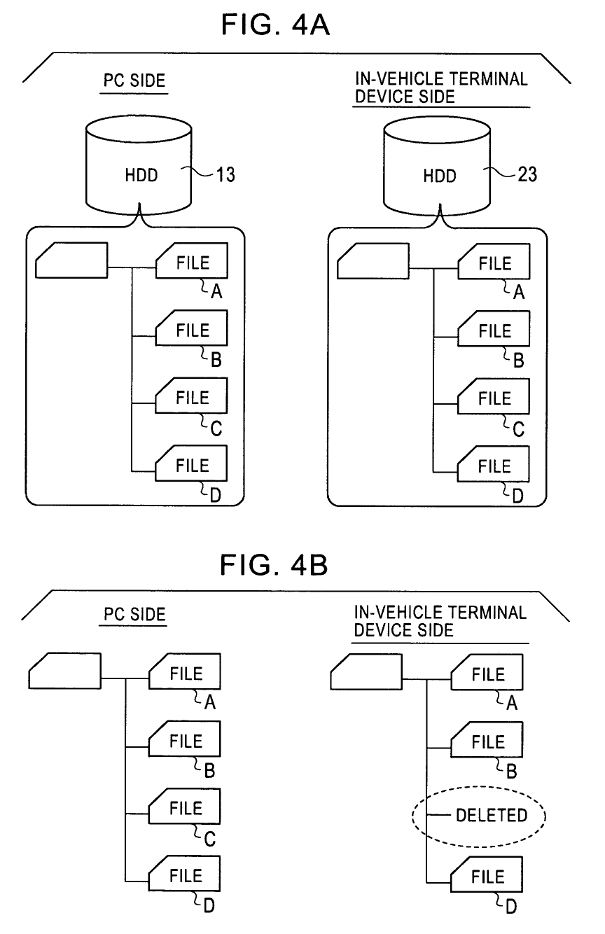

It is assumed that the same content of, for example, music files is stored in the HDD 23 of the in-vehicle terminal device 20 and the HDD 13 of the PC 10. FIG. 4A is a schematic view showing this state. In FIG. 4A, four music files A, B, C, and D are stored in the HDDs 13 and 23.

In this state, referring to the process flow shown in FIG. 2, in step S1, the control unit 21 determines whether a user has requested deletion of any of the music files stored in the HDD 23 in response to the user's instruction received from the operation unit 24. In this case, only one file or all files may be subjected to deletion. In a case shown in FIG. 4B, the file C is subjected to deletion. When the control unit 21 determines that the user has requested deletion of any of the music files stored in the HDD 23, the control unit 21 deletes the data of the files subjected to deletion from the storage area of the HDD 23, and the process proceeds to step S2. Otherwise, step S1 is repeated.

In step S2, the control unit 21 creates deletion history to which the information (the information for identifying files, for example, the names of albums and the names of tunes) on the deleted files is written and temporarily stores the created deletion history in the deletion-history storage unit 26.

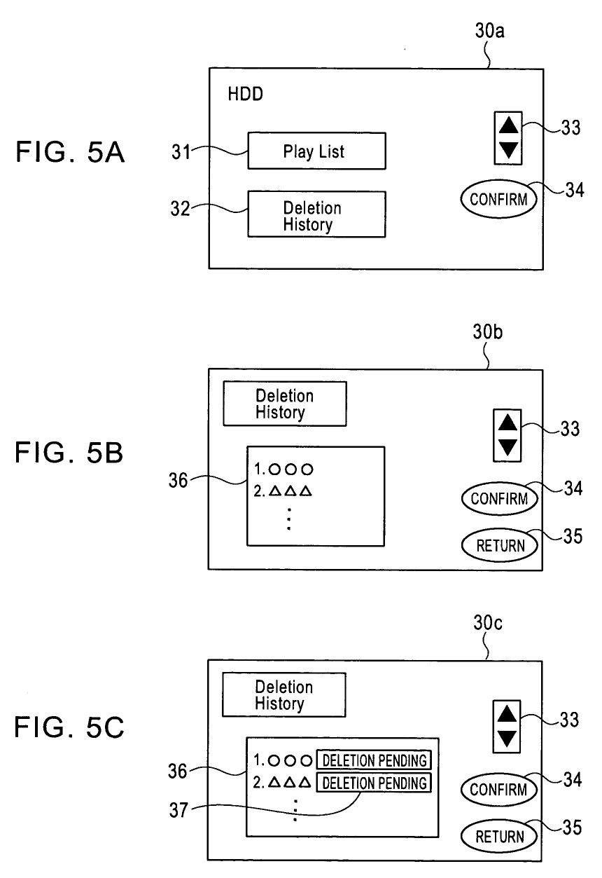

In step S3, the control unit 21 displays the deletion history stored in the deletion-history storage unit 26 on the screen of the display unit 25 in response to the user's instruction received from the operation unit 24. FIG. 5B shows a typical screen display in this embodiment.

FIG. 5A shows a display screen 30a for selecting types of operation performed on the HDD 23. The display screen 30a displays a “Play List” option 31 for displaying a list of music files stored in the HDD 23, a “Deletion History” option 32 for displaying a list of deleted files, a select button 33, and a confirm button 34. When the user selects the “Deletion History” option 32 by operating the select button 33 and presses the confirm button 34 on the display screen 30a, a display screen 30b shown in FIG. 5B appears in the first embodiment, and a display screen 30c shown in FIG. 5C appears in a second embodiment that is described below. The display screen 30b displays a deleted-file list 36, the select button 33, the confirm button 34, and a return button 35 for returning to the previous screen.

In step S4, the control unit 21 determines whether the user has selected any deleted file that the user needs to obtain from the deletion history displayed on the screen of the display unit 25, for example, the deleted-file list 36 displayed on the display screen 30b shown in FIG. 5B, in response to the user's instruction received from the operation unit 24. When the control unit 21 determines that the user has selected any of the deleted files from the deletion history, the process proceeds to step S5. Otherwise, the process is completed.

In step S5, the information, for example, the names of albums and the names of tunes, for identifying the deleted file that has been selected is transmitted to the PC 10 via the wireless LAN communication controller 22 under the control of the control unit 21. That is to say, the PC 10 is requested to transfer the music file that was deleted from the in-vehicle terminal device 20 (the file C in the case shown in FIG. 4B).

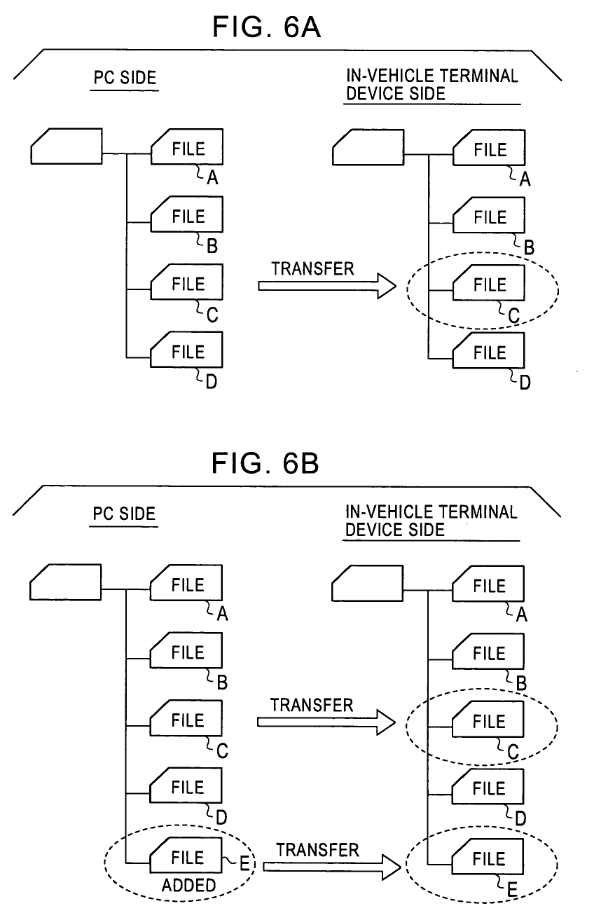

In step S6, the requested file (the deleted file C) that has been transferred from the PC 10 in response to the file transfer request is received via the wireless LAN communication controller 22. FIG. 6A is a schematic view showing this process of file transfer. In step S6, when a new file has been added in the PC 10, the added file (a file E in a case shown in FIG. 6B) is also simultaneously transferred as the difference, which has been generated in the PC 10, between the contents in the PC 10 and the in-vehicle terminal device 20.

The file obtained in this process is stored in a predetermined storage area of the HDD 23 via the control unit 21. This file is processed as necessary through the control unit 21, the audio processing unit 27, and the power amplifier 28, in response to the user's instruction entered via the operation unit 24, generates sound from the speaker 29. Then, the process is completed.

In the process shown in FIG. 2 according to the first embodiment, the control unit 21 creates deletion history when files (content) have been deleted from the in-vehicle terminal device 20, and the deletion history is displayed on the screen of the display unit 25 so that the information for identifying a deleted file that has been selected from the deletion history by the user can be transferred to the PC 10. That is to say, the in-vehicle terminal device 20 requests the PC 10, which has the same files (content) as the in-vehicle terminal device 20, to transfer the deleted file.

Accordingly, the file deleted from the in-vehicle terminal device 20 can be obtained from the PC 10, and the data of the file can be reproduced as necessary. Moreover, even when the capacity of the HDD 23 is limited, stored files (content) can be deleted as necessary. Thus, an efficient operation of the HDD 23 can be achieved.

In the aforementioned embodiment, although a music file (content) that was deleted from the in-vehicle terminal device 20 is obtained from the PC 10, a device that obtains content is not limited to an in-vehicle device. That is to say, the present invention is applicable to a terminal device that can connect to and communicate with an information processing device, such as a PC, that includes a recording medium, such as an HDD, and that includes a limited-capacity recording medium that stores content obtained from the information processing device.

Moreover, in the aforementioned embodiment, the PC 10 transfers a piece of content to the in-vehicle terminal device 20 in response to a transfer request that is manually entered by the user from the operation unit 24 of the in-vehicle terminal device 20. However, the PC 10 does not necessarily need to transfer a piece of content to the in-vehicle terminal device 20 in response to a transfer request from the in-vehicle terminal device 20 and may automatically transfer a piece of content to the in-vehicle terminal device 20. In this case, in the PC 10, the control unit 11 compares the content in the HDD 13 of the PC 10 with the content in the HDD 23 of the in-vehicle terminal device 20 at predetermined intervals, extracts only the difference between the contents, and transfers the difference to the in-vehicle terminal device 20. In this case, the difference between the contents includes content that has been added to the content in the HDD 13 of the PC 10 in a situation in which the content stored in the HDD 13 is the same as that stored in the HDD 23 of the in-vehicle terminal device 20, and a part of the content in the HDD 23 of the in-vehicle terminal device 20 that has been deleted.

In the process shown in FIG. 2 according to the first embodiment, when music files have been deleted from the in-vehicle terminal device 20, the deletion history of the deleted files is created. Then, the files deleted from the in-vehicle terminal device 20 can be obtained as necessary by requesting with reference to the deletion history (the deleted-file list 36 shown in FIG. 5B) the PC 10 to transfer the deleted files. However, when music files that are the same as those that were deleted from the in-vehicle terminal device 20 were deleted from the PC 10 and do not exist in the PC 10, the in-vehicle terminal device 20 cannot obtain these music files. The second embodiment, which is described below, provides a solution to this problem.

Second Embodiment

It is assumed that the same content (the four files A to D shown in FIG. 4A) is stored in the HDD 23 of the in-vehicle terminal device 20 and the HDD 13 of the PC 10, as in the first embodiment (FIG. 2).

In this state, referring to the process flow shown in FIG. 3, in step S11, the control unit 21 determines whether a user has requested deletion of any of the files stored in the HDD 23 in response to the user's instruction received from the operation unit 24. In this case, only one file or all files may be subjected to a deletion request. When the control unit 21 determines that the user has requested deletion of any of the files stored in the HDD 23, the control unit 21 does not immediately delete the requested files but puts these files into a deletion-pending state unlike the process in step S1 (FIG. 2) in the first embodiment, i.e., these files remain in the storage area of the HDD 23, and the process proceeds to step S12. Otherwise, step S11 is repeated.

In step S12, the control unit 21 creates deletion history to which the information (the information indicating that the requested files have not been deleted) on the requested files is written and temporarily stores the created deletion history in the deletion-history storage unit 26, as in the process in step S2 in the first embodiment.

In step S13, the control unit 21 displays the deletion history stored in the deletion-history storage unit 26 on the screen of the display unit 25 in response to the user's instruction received from the operation unit 24, as in the process in step S3 in the first embodiment. FIG. 5C shows a typical screen display in this case. In FIG. 5C, information 37 indicating that the files subjected to a deletion request have not been deleted and are in a deletion-pending state is added to the deleted-file list 36 displayed on the display screen 30c. When the deleted-file list 36 is displayed, it is preferable that the information 37 be displayed in a manner in which the information 37 is relatively emphasized to attract the user's attention.

In step S14, the control unit 21 determines whether the user has requested deletion of any file in a deletion-pending state in the deletion history displayed on the screen of the display unit 25, for example, the deleted-file list 36 displayed on the display screen 30c shown in FIG. 5C, in response to the user's instruction received from the operation unit 24. When the control unit 21 determines that the user has requested deletion of any of the files in a deletion-pending state in the deletion history, the process proceeds to step S15. Otherwise, the process is completed.

In step S15, the control unit 21 determines in cooperation with the control unit 11 and the wireless LAN communication controller 12 of the PC 10 via the wireless LAN communication controller 22 whether the file in a deletion-pending state requested to be deleted exists in the HDD 13 of the PC 10. When the control unit 21 determines that the file in a deletion-pending state requested to be deleted exists in the HDD 13 of the PC 10, the process proceeds to step S16. Otherwise, the process proceeds to step S17.

In step S16, the control unit 21 deletes the file in a deletion-pending state requested to be deleted from the music files stored in the HDD 23 in response to the user's instruction received from the operation unit 24. In step S16, the data of the file requested to be deleted is deleted from the storage area of the HDD 23. Then, the process is completed.

On the other hand, in step S17, a warning message stating that the file in a deletion-pending state requested to be deleted does not exist in the PC 10 is displayed on the screen of the display unit 25 under the control of the control unit 21. For example, a message saying “The file requested to be deleted exists only in the in-vehicle terminal. Do you continue the operation to delete the file?” is displayed.

In step S18, the control unit 21 determines whether the user has confirmed deletion of the file in a deletion-pending state in response to the user's instruction entered via the operation unit 24. When the control unit 21 determines that the user has confirmed deletion of the file in a deletion-pending state, the process proceeds to step S16 where the aforementioned process is performed. Otherwise, the process proceeds to step S19.

In step S19, the control unit 21 transfers the file in a deletion-pending state requested to be deleted to the PC 10 in response to the user's instruction entered via the operation unit 24. Thus, the user can obtain the file subsequently when the user needs the file. Then, the process is completed.

In the second embodiment shown in FIG. 3, in the in-vehicle terminal device 20, the control unit 21 does not delete a file (content) but puts the file into a deletion-pending state when deletion of the file has been requested. Then, the control unit 21 actually deletes the file in a deletion-pending state when the control unit 21 determines that the file exists in the HDD 13 of the PC 10, as described above. For example, a file in the in-vehicle terminal device 20 is not deleted when deletion of the file has been requested by the user in a place remote from the user's home. Subsequently, the file is actually deleted when the user has confirmed the existence of the file in the HDD 13 of the PC 10 at home.

Thus, in the second embodiment, an efficient operation of the HDD 23 can be achieved, as in the first embodiment shown in FIG. 2.

Moreover, in the in-vehicle terminal device 20, a file is not deleted and remains in the storage area of the HDD 23 and the deletion history of the file in a delete-pending state is created and stored when deletion of the file has been requested. Thus, the deletion history of the file can be displayed on the screen of the display unit 25 as necessary so that the user can confirm deletion of the file requested to be deleted. That is to say, the user can check whether the user has correctly specified the file to be deleted when the deletion history of the file is displayed. Thus, the user's misoperation can be suppressed.

In the aforementioned embodiments, the in-vehicle terminal device 20 is connected to the PC 10 via a wireless LAN. Alternatively, the in-vehicle terminal device 20 may be connected to the PC 10 by wire communication using a cable such as a USB cable.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A terminal device that is virtually connected to an external processing device that includes a recording medium that stores content so that the terminal device can communicate with the external processing device, the terminal device comprising:
an input unit operable to receive a user's instruction;
a display operable to present information;
a storage unit operable to store content; and
a control unit connected to the input unit, the display, and the storage unit,
wherein the control unit is operable to create a deletion history when a piece of content stored in the storage unit is deleted, and subsequently display the deletion history on the display and request that the external processing device transfer the deleted piece of content to the control unit when the deleted piece of content is selected from the deletion history via the user's instruction.

2. The terminal device according to claim 1, wherein the terminal device is included in a vehicle.

3. A terminal device that is virtually connected to an external processing device that includes a recording medium that stores content so that the terminal device can communicate with the external processing device, the terminal device comprising:
an input unit operable to receive a user's instruction;
a storage unit operable to store content; and
a control unit connected to the input unit and the storage unit,
wherein the control unit does not immediately delete a piece of content stored in the storage unit when deletion of the piece of content is requested but rather places the piece of content into a deletion-pending queue and only actually deletes the piece of content after the control unit has determined that the piece of content exists in the recording medium of the external processing device.

4. The terminal device according to claim 3, wherein the terminal device is included in a vehicle.

5. The terminal device according to claim 3, wherein the control unit is operable to create a deletion history that includes information indicating that the piece of content stored in the storage unit has been placed into the deletion-pending queue and not actually deleted after deletion of the piece of content has been requested.

6. The terminal device according to claim 5, further comprising a display operable to present information, wherein the control unit is operable to present the deletion history and the information indicating that the piece of content has been placed into the deletion-pending queue and not actually deleted on the display in a manner in which the information is emphasized when the user's instruction has been received.

7. The terminal device according to claim 6, wherein, when deletion of the piece of content that has been placed into the deletion-pending queue has been requested, the control unit presents a warning message on the display if the piece of content does not exist in the recording medium of the external processing device.

8. The terminal device according to claim 7, wherein the control unit transfers the piece of content for which deletion has been requested to the external processing device upon determining that the piece of content does not exist in the recording medium of the external processing device.

9. A content deletion and transfer control system comprising:
an external processing device operable to store content; and
a terminal device comprising:
an input unit operable to receive a user's instruction;
a display operable to present information;
a first storage unit operable to store content; and
a first control unit connected to the input unit, the display, and the first storage unit,
wherein the first control unit is operable to create a deletion history when a piece of content stored in the first storage unit is deleted from the first storage unit, and subsequently present the deletion history on the display and request the external processing device to transfer the deleted piece of content to the terminal device when the deleted piece of content is selected from the deletion history via the user's instruction, and
the external processing device and the terminal device are virtually connected to each other so that the external processing device and the terminal device can communicate with each other.

10. The content deletion and transfer control system according to claim 9, wherein the terminal device is included in a vehicle.

11. The content deletion and transfer control system according to claim 9, wherein the external processing device comprises:
a second storage unit operable to store at least approximately the same content as the first storage unit; and
a second control unit connected to the second storage unit,
wherein the second control unit, in response to a transfer request received from the terminal device, is operable to extract the deleted piece of content from the content stored in the second storage unit and transfer the deleted piece of content to the terminal device.

12. The content deletion and transfer control system according to claim 11, wherein, when a new piece of content has been added to the content stored in the second storage unit, the second control unit simultaneously transfers the new piece of content to the terminal device upon transferring the deleted piece of content requested.

13. A content deletion and transfer control system comprising:
an external processing device operable to store content; and
a terminal device comprising:
an input unit operable to receive a user's instruction;
a storage unit operable to store content; and
a control unit connected to the input unit and the storage unit,
wherein the control unit does not immediately delete a piece of content stored in the storage unit when deletion of the piece of content is requested but rather places the piece of content into a deletion-pending queue and only actually deletes the piece of content from the storage unit after the control unit has determined that the piece of content exists in the external processing device, and
the external processing device and the terminal device are virtually connected to each other so that the external processing device and the terminal device can communicate with each other.

14. The content deletion and transfer control system according to claim 13, wherein the terminal device is included in a vehicle.

15. The content deletion and transfer control system according to claim 13, wherein the control unit creates a deletion history that includes information indicating that the piece of content stored in the storage unit has been placed into a deletion-pending queue and not actually deleted after deletion of the piece of content from the storage unit has been requested.

16. The content deletion and transfer control system according to claim 15, wherein the terminal device includes a display operable to present information,
the control unit being operable to present the deletion history and the information indicating that the piece of content has been placed into a deletion-pending queue and not actually deleted on the display in a manner in which the information is emphasized when the user's instruction has been received.

17. The content deletion and transfer control system according to claim 16, wherein, when deletion of the piece of content has been requested and the piece of content has been placed into the deletion-pending queue and not actually deleted, the control unit presents a warning message on the display upon determining that the piece of content does not exist in the external processing device.

18. The content deletion and transfer control system according to claim 17, wherein the control unit is operable to transfer the piece of content requested to be deleted to the external processing device upon determining that the piece of content does not exist in the external processing device.

19. A method for controlling content deletion in a system that includes a terminal device that stores content and an external processing device that at least stores approximately the same content as the terminal device, the external processing device and the terminal device being virtually connected to each other so that the external processing device and the terminal device can communicate with each other, the method comprising:
placing a piece of content stored in the terminal device in a deletion-pending queue when deletion of the piece of content from the terminal device has been requested instead of immediately deleting the piece of content; and
actually deleting the piece of content from the terminal device upon determining that the piece of content exists in the external processing device.

20. A method according to claim 19, further comprising:
determining whether the piece of content that has been placed into the deletion-pending queue already exists in the external processing device; and
transferring the piece of content to the external processing device upon determining that the piece of content does not already exist in the external processing device.
